(19) United States
(12) Patent Application Publication
(10) Pub. No.: US 2014/0049022 A1
(43) Pub. Date: Feb. 20, 2014

(54) ADJUSTABLE AND EXTENSIBLE BICYCLE FRAME

(71) Applicant: Brazen Bikes Ltd., Bragg Creek (CA)

(72) Inventor: Anthony Robert DOPF, Bragg Creek (CA)

(73) Assignee: Brazen Bikes Ltd., Bragg Creek (CA)

(21) Appl. No.: 13/965,580

(22) Filed: Aug. 13, 2013

Related U.S. Application Data
(60) Provisional application No. 61/683,115, filed on Aug. 14, 2012.

(51) Int. Cl. B62K 3/04; B62K 21/02

(52) U.S. Cl. CPC B62K 3/04; B62K 21/02
USPC 280/278; 280/279

(57) ABSTRACT

An adjustable bicycle is provided as well as an adjustable frame assembly and an adjustable steering column assembly. The frame assembly includes a seat tube, a head tube and a top tube assembly connecting the seat tube to the head tube. The top tube assembly includes a female tube and a male tube having a front attached to the head tube and the rear telescopically engaging with the female tube. The female tube telescopically slides within the first male tube. A locking mechanism fixes the position of the female tube relative to the male tube. The adjustable steering column assembly includes a steerer tube having a top and a bottom, the bottom being operatively engaged within the head tube. A telescopic tube having a bottom telescopically engages within the steerer tube. A steering column locking mechanism fixes the position of the telescopic tube within the steerer tube.

### CROSS REFERENCE TO RELATED APPLICATIONS

This application claims the benefits of priority under 35 U.S.C. §119 and 120 of U.S. Provisional Patent Application No. 61/683,115, filed on Aug. 14, 2012, the entire contents of which are incorporated by reference.

### FIELD OF THE INVENTION

This invention relates to an extensible and adjustable bicycle frames, and specifically to bicycle frames that can be easily extended in length and in handlebar height without the use of tools.

### BACKGROUND OF THE INVENTION

At the present time, with bicycles, there is only a small amount of fitting or size adjustment that is available to properly fit a bicycle to a cyclist. Primarily the seat height and position can be altered, and to a lesser degree, the handlebar height can be changed in order to fit the bicycle to the cyclist. Should the desired distance from saddle to handlebars fall outside of this limited adjustment range, a cyclist must instead be fit to a bicycle having a different size frame to accomplish proper fitting. As is readily understood, having to substitute a different frame and/or stock a different frame can be costly and inconvenient to the various people that have an interest in bicycling including cyclists themselves, retailers and/or bike operators such as bicycle tour operators and municipal bike share operators.

For example, with growing children, bicycles must be frequently replaced with a larger bicycle for the child. In some cases, due to the rate of growth of the child, a bicycle may only properly fit the child for a few months. For other users, such as bicycle retailers and rental companies, these groups must fit bicycles to a wide range of different-sized people which requires stocking of a larger number of different bicycle frames. Further still, bike fitters during the fitting process may require a number of different frames that must be used in order to properly determine the right bicycle frame to fit a cyclist.

As a result, there has been a need for an improved bicycle and bicycle frame system that overcomes the foregoing problems and allows a wider range of sizes of people to be fit to a single size bicycle.

The patent literature illustrates previous attempts at creating bicycle frames which can be size adjusted, such as U.S. Pat. No. 5,072,961 for a Bicycle with Universal Adjustable Frame, and U.S. Pat. No. 7,988,174 for an Electrically-Extendible Bicycle or U.S. Pat. No. 7,926,386 for Detachable Telescoping Adjustable Gooseneck for a Bicycle. While each of these systems provide a degree of adaptability, each are relatively complex, cumbersome, and potentially impractical to make and use. In addition, minimizing bicycle weight is a critical factor in maintaining an efficient vehicle, and these past systems typically add considerable weight to the overall weight of the bicycle which then results in the bicycles not being widely used by bicycling community.

### BRIEF SUMMARY OF THE INVENTION

In view of the foregoing, the invention describes a new type of bicycle frame which allows for easy size adjustment to properly fit a cyclist to the bicycle, without significantly impacting the stiffness, handling, or weight of the bicycle. The invention accomplishes these objectives through the use of a parallel pair of male tubes attached to the head tube, which slide telescopically into a mating pair of hollow female tubes, comprising the forwardmost portion of the main bicycle frame. Quick release clamps, similar to those used for standard seatpost adjustment, enable the sliding tubes to be locked in the desired position.

By solving the aforementioned size adjustment problem, this invention has application in a number of fields including rental bicycles, children's bicycles, bicycle retailers, and bicycle fitters.

More specifically, having a bicycle that is “one size fits all” can simplify logistics for bicycle rental agencies, bicycle touring companies, and municipal bicycle share programs, as this invention enables a single bicycle to fit a wider range of cyclists thus minimizing the need to stock a wide range of frame sizes.

In the field of children's bicycles, the bicycle frame can be incrementally expanded to fit the growing child, ensuring a proper fit for a longer age span of the child. That is, a single extensible frame as described herein may serve during the time normally occupied by 2 or 3 traditional fixed frames, thus saving money in replacement costs.

A third field of use is for bicycle retailers to enable potential customers to test a complete range of sizes on a single bicycle, to quickly and accurately determine whether an “off-the-shelf” bicycle will provide them with the best fit, even if that bicycle is not currently in stock, or alternatively to determine frame size measurements for ordering a custom built bicycle.

A still further field of use is in the professional bicycle fitting industry. In this field, specialists attempt to fine-tune a cyclist's position for comfort and efficiency, but are generally limited to performing their craft indoors on a stationary bike. In accordance with the invention, by enabling a cyclist to cycle outdoors on their favorite routes in real world conditions, and still make numerous simple adjustments until they feel comfortable in an optimum riding position, enhances the ability of a cyclist to most accurately determine the best traditional fixed-size frame to use in the future.

More specifically, and in accordance with the invention, there is provided an extensible bicycle frame comprising: a seat tube; a head tube; a top tube assembly connecting the seat tube to the head tube, the top tube assembly including: a first female tube having a front end and a rear end, the rear end attached to the seat tube; a first male tube having a front end and a rear end, the front end attached to the head tube and the rear end telescopically engaged with the front end of the first female tube; wherein the length of the top tube assembly can be adjusted by telescopically sliding the first female tube within the first male tube; and a locking mechanism for fixing the position of the first female tube relative to the first male tube.

In another embodiment, the extensible frame includes a second top tube assembly located above and parallel with the top tube assembly, the second top tube assembly including: a second female tube having a front end and a rear end, the rear end attached to the seat tube or first female tube; a second male tube having a front end and a rear end, the front attached to the head tube and the rear end telescopically engaged with the front end of the second female tube.

In another embodiment, the bicycle frame further comprises a second locking mechanism for fixing the position of the second female tube relative to the second male tube.

In yet another embodiment, the first and second top tube assemblies provide planar alignment between the head tube and the seat tube.

In another embodiment, the front end of each female tube front end includes an internal bushing and the rear end of each male tube includes an external end stop to prevent inadvertent disassembly of each male tube from each female tube. In one embodiment, each internal bushing has a bushing leading edge located adjacent the female tube front end, and each external end stop has an end stop leading edge located adjacent the male tube rear end and wherein each bushing and end stop leading edges are tapered to facilitate insertion of each male tube rear end into each female tube front end respectively.

In another aspect, the invention provides an adjustable steering column for a bicycle comprising: a head tube; a steerer tube having a top end and a bottom end, the bottom end operatively engaged within the head tube; a telescopic tube having a bottom end telescopically engaged within the steerer tube; and a steering column locking mechanism for fixing the position of the telescopic tube within the steerer tube; wherein the height of the telescopic steering column can be adjusted without tools.

In one embodiment, the steerer tube and telescopic tube further include an anti-rotation mechanism to prevent relative angular displacement during height adjustment.

In yet another aspect, the invention provides an adjustable bicycle comprising: an adjustable frame assembly, the adjustable frame assembly including: a seat tube; a head tube; a top tube assembly connecting the seat tube to the head tube, the top tube assembly including: a first female tube having a front end and a rear end, the rear end attached to the seat tube; a first male tube having a front end and a rear end, the front end attached to the head tube and the rear end telescopically engaged with the front end of the first female tube; wherein the length of the top tube assembly can be adjusted by telescopically sliding the first female tube within the first male tube; and a locking mechanism for fixing the position of the first female tube relative to the first male tube and an adjustable steering column assembly, the adjustable steering column assembly including: a steerer tube having a top end and a bottom end, the bottom end operatively engaged within the head tube; a telescopic tube having a bottom end telescopically engaged within the steerer tube; and a steering column locking mechanism for fixing the position of the telescopic tube within the steerer tube; wherein the height of the telescopic steering column can be adjusted without tools.

### BRIEF DESCRIPTION OF THE DRAWINGS

The invention is described with reference to the accompanying figures in which:

FIG. 1 is a plan view of an Extensible Bicycle Frame, shown without wheels, gearing, or pedals for simplicity and clarity;

FIG. 2 is a top view of a typical Quick Release Clamp, commonly used for seatpost adjustments;

FIG. 3 is an enlarged plan view of sliding tubes of an Extensible Bicycle Frame, shown in first (i) and second (ii) position;

FIG. 4 is a section view of male and female tubes with included end stops and bushings showing four sequential steps of engagement (i-iv);

FIG. 5 is a partial view of a steering column height adjustment system;

FIG. 6 is a section view of a steering column height adjustment system;

FIG. 7 is a plan view of an Extensible Bicycle with truncated Upper Top Tube, shown in context with conventional bicycle components such as wheels, pedals, and chain included; and,

FIG. 8 is a section view of a Steerer Tube and Telescopic Column with Key and Keyway.

### DETAILED DESCRIPTION OF THE INVENTION

With reference to the figures, an adjustable and extensible bicycle frame is described.

The bicycle frame may be built from any of the materials commonly used in the bicycle building industry such as steel, stainless steel, aluminum alloys, titanium alloys, and carbon fibre composites. Other, less conventional materials, such as wood, bamboo, fiberglass, plastics, or other materials not listed here, could also be used in the construction as understood by those skilled in the art.

Each material also has well known processes which are suited to creating the joints in the frame between the generally hollow tubular sections. For instance, steel bicycle tubing is most commonly joined by welding, fillet brazing, or with silver soldered lugged connections, stainless steel bicycle tubing is joined with welding or silver soldered lugs. Aluminum and titanium alloy tubes are most frequently joined by welding, whereas carbon fiber tubes may be joined with adhesives and additional layers of carbon fiber. The invention may be equally well adapted to any of the materials joined with the aforementioned processes, but shall for the purposes of illustration, be described in the context of a fillet brazed steel frame.

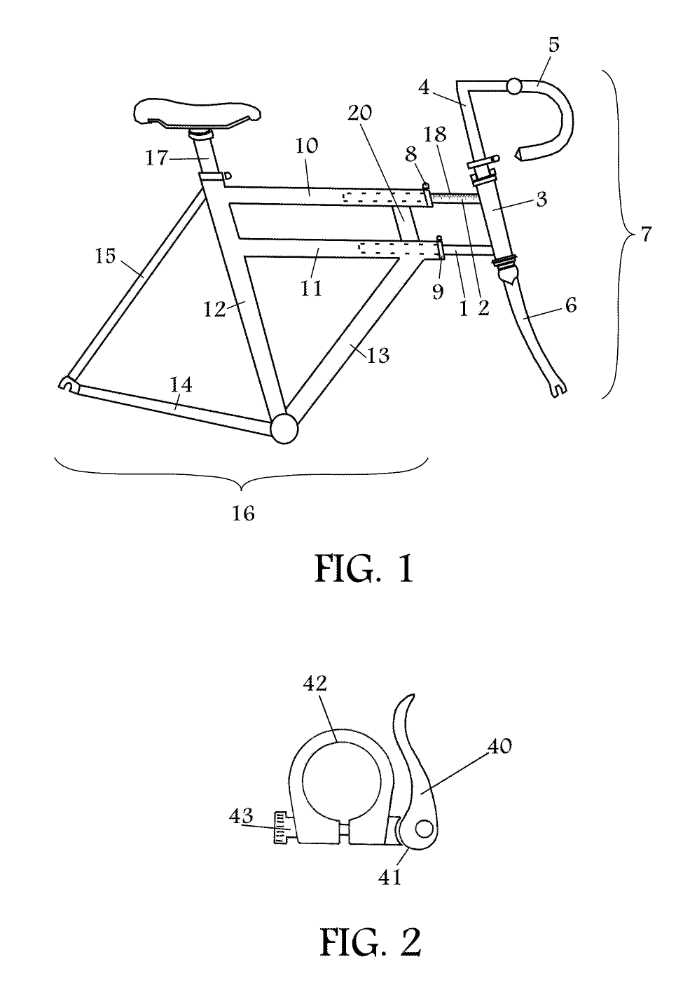

FIG. 1 isolates the pertinent details of the invention, the frame and steering assembly, while not showing wheels, gearing, and pedals to aid in clarity. A high level description of the function of the frame and steering assembly is provided with reference to FIG. 1.

A pair of Sliding Tubes 1 and 2 having parallel axes and of preferably circular cross section are attached with one of the aforementioned joining processes, such as fillet brazing, to the Head Tube 3. The Sliding Tubes 1 and 2 are telescopically engaged within Upper Top Tube 10 and Lower Top Tube 11 having corresponding parallel axes. The combination of Sliding Tubes 1 and 2, Head Tube 3, Stem 4, Handle Bars 5, and Fork 6 is referred to as the Steering Assembly 7. Consequently, the entire Steering Assembly 7 moves with the Sliding Tubes 1 and 2. The Sliding Tubes 1 and 2 may be secured within the Upper Top Tube 10 and Lower Top Tube 11 by quick release clamps 8 and 9. When the quick release clamps 8 and 9 are in the open or disengaged position, Sliding Tubes 1 and 2 may freely slide telescopically into the Upper Top Tube 10 and Lower Top Tube 11. The Upper and Lower Top Tubes 10 and 11 are connected with the Seat Tube 12, Down Tube 13, Chain Stays 14, and Seat Stays 15, and together form the Rear Bicycle Frame 16. When quick release clamps 8 and 9 are then placed in the closed or engaged position, Sliding Tubes 1 and 2 are prevented from moving with respect to the Top Tubes 10 and 11. This has the effect of locking the Steering Assembly 7 in the desired position relative to the Rear Bicycle Frame 16, and enabling the desired frame size to be achieved. A Crosstube 20 positioned perpendicular to and attached between the Upper and Lower Top Tubes 10 and 11 may be optionally incorporated for added stability and strength of the frame

For convenience, a measurement scale 18 may be inscribed in units of “cm” or “inches” on the Upper Sliding Tube 2, allowing the frame size to be read at the point where the Upper Sliding Tube 2 enters the quick release clamp 8. As it is common to express bicycle frame size as the horizontal distance from the top tube/head tube junction to the seat tube, also known as the “effective top tube length”. Thus it is possible to use the measurement taken from the extensible bicycle to fit a cyclist with a standard bicycle, much like shoe size can be determined from a shoe sizing scale. This has the advantage of allowing a cyclist to readily adjust the bicycle to their size based on known knowledge of their size.

With reference to FIGS. 2-6, individual components and features of the assemblies are described in greater detail so as to provide a clear understanding of the implementation of the invention. FIG. 2 provides a top view of a standard quick release clamp, a well-established bicycle fixture commonly used at the interface between the Seat Tube 12 and the Seat Post 17, to enable a cyclist to easily adjust the saddle height. A quick release clamp typically consists of a lever 40 with a cam 41 that cinches the interior surface 42 of the clamp tight against an external tube when the lever 40 is closed. A threaded adjusting barrel 43 may be used to fine tune the cinched diameter.

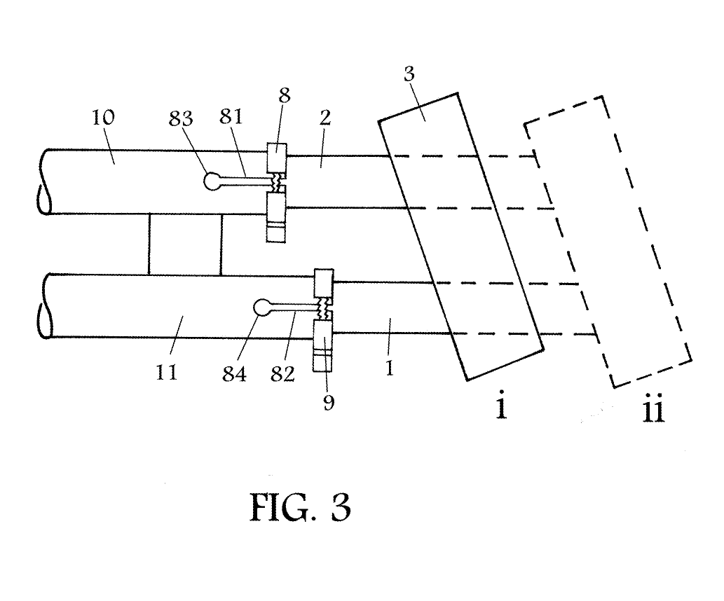

The Sliding Tube to Top Tube interface, is shown most clearly in FIG. 3. As shown, the ends of the Top Tubes 10 and 11 are slit axially 81 and 82, so as to allow them to flex inwards and grip the Sliding Tubes 1 and 2 securely when the quick release clamps 8 and 9 are engaged. As is known, it is common when using quick release clamps, to drill relief holes 83 and 84 at the end of the slits 81 and 82, to reduce the stress concentration at these points, and to prevent a fatigue crack from originating here. FIG. 3 shows how the Sliding Tubes 1 and 2 and Head Tube 3 may be moved from an initial position (i) out to a second position (ii) indicated by dashed lines. This movement is accomplished by loosening the quick release clamps 8 and 9, pulling the Sliding Tubes 1 and 2 and Head Tube 3 outwards to the desired position and re-tightening the quick release clamps 8 and 9.

Considering again FIG. 1, the purpose of utilizing two sets of parallel telescoping tubes spaced vertically apart from each other in the plane of the Rear Bicycle Frame 16 is to maintain as closely as possible the planar alignment of Head Tube 3 with the Rear Bicycle Frame 16. The Head Tube 3 establishes the planar orientation for the Steering Assembly 7, and misalignment between the Steering Assembly 7 and the Rear Bicycle Frame 16 would produce poor ride quality. While a single combination of a telescopic male and female tube of circular cross section would provide a mechanism for frame size adjustment, it would not provide an inherent mechanism for maintaining Head Tube 3 planar alignment with the Rear Bicycle Frame 16. One may consider alternative embodiments to control the planar alignment, such as telescoping tubing of a rectangular cross-section and/or the use of keyways, pins or splines.

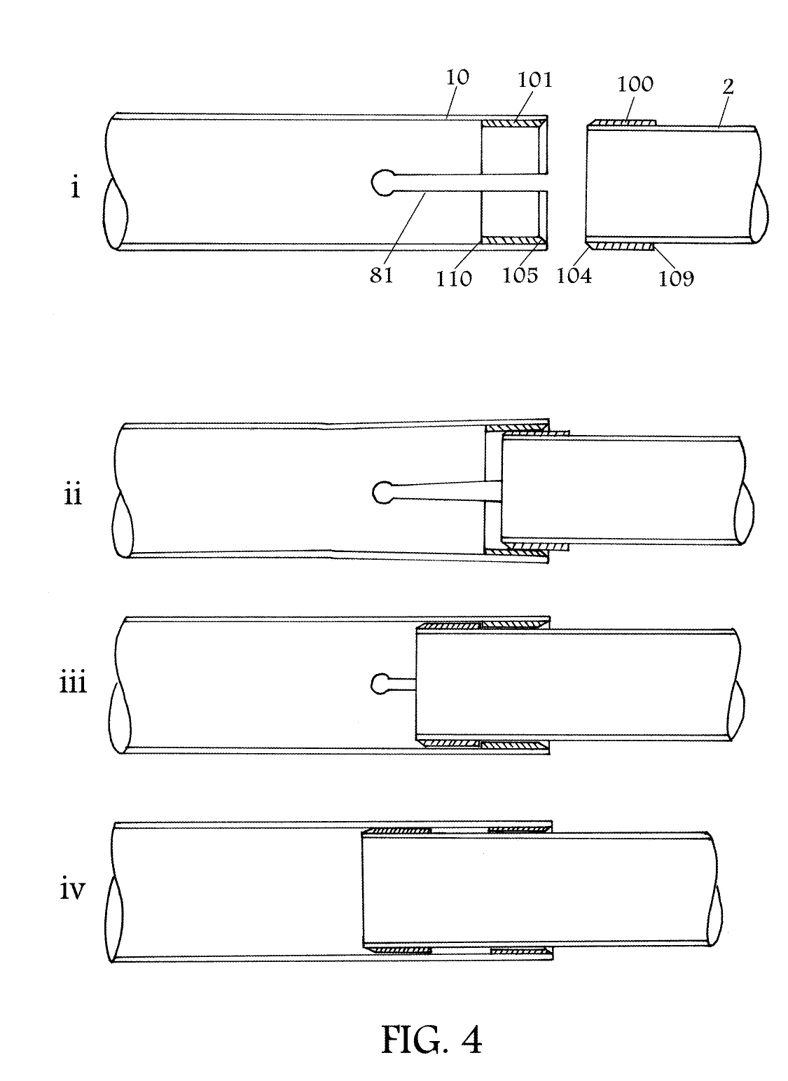

FIG. 4 shows in detail Upper Top Tube 10 and Sliding Tube 2 in cross section, in four sequential assembly steps labeled i, ii, iii, and iv. The Figure demonstrates the use of a preferred embodiment consisting of an End Stop 100 and Bushing 101. The Upper Top Tube 10 and Lower Top Tube 11 act in an identical manner, so only the Upper Top Tube 10 (and mating Sliding Tube 2) are shown for the sake of simplicity.

End Stop 100 may be fixed externally onto the end of the Sliding Tube 2, and similarly Bushing 101 may be fixed internally to the end of the Upper Top Tube 10. In the preferred embodiment, the End Stop 100 and Bushing 101 may both be constructed from brass shim stock, approximately 0.8 mm thick, formed into cylindrical bands, and silver soldered in place. The End Stop 100 and Bushing 101 may both be constructed with a tapered surface on the leading edges 104 and 105, which assists initial assembly of the Sliding Tube 2 into the Upper Top Tube 10. The Slit End 81 of the Upper Top Tube 10 is designed to allow the Upper Top Tube 10 to expand elastically as seen in sequence ii, sufficient for passage of the Sliding Tube 2 and end stop 100 to proceed past the bushing 101 of the Upper Top Tube 10. Once the End Stop 100 is past the Bushing 101, as diagramed in sequence iii, the Upper Top Tube 10 elastically returns to its initial shape. Further insertion of Sliding Tube 2 into Upper Top Tube 10 is shown in sequence iv). The material properties of the Upper Top Tube 10, and more specifically the yield strength of the steel used in this example, will determine the minimum length of the Slit End 81 that is necessary to allow the material to remain in its elastic range without exhibiting plastic deformation.

The primary benefit of the End Stop 100 is that it prevents inadvertent disassembly of the Steering Assembly 7 from the Rear Bicycle Frame 16 during regular size adjustments. This is achieved by forming the trailing edges 109 and 110 of the End Stop 100 and Bushing 101 perpendicular to the tube axis. When the Sliding Tube 2 is pulled outward to the maximum extent of travel, the trailing edge 109 of the End Stop 100 will abut squarely upon the trailing edge 110 of the Bushing 101, as can be visualized in sequence iii, but without a taper present to expand the slit ends of the tube, the Sliding Tube 2 will be prevented from complete disassembly. Should it be necessary to separate the Sliding Tube 2 from the Top Tube 10 for maintenance purposes, the Slit End 81 may be wedged open with a flat bladed tool, allowing the End Stop 100 to pass through the Bushing 101, and the Sliding Tube 2 may be fully removed from the Upper Top Tube 10.

A secondary benefit of End Stop 100 and Bushing 101 are to guide the Sliding Tubes 1 and 2 smoothly with reduced friction while making adjustments to the frame size. The End Stop 100 and Bushing 101 also serve to reduce the lateral, angular, and rotational play experienced by the Steering Assembly 7 relative to the Rear Bicycle Frame 16 during size adjustments while the quick release clamps 8 and 9 are in the disengaged position.

A further benefit of Bushing 101 is to enable the use of standard bicycle tubing sizes and wall thicknesses. In the preferred embodiment, the Upper Top Tube 10 may be constructed from cro-moly steel bicycle tubing available in a standard size of 28.6 mm OD (Outside Diameter)×27.4 mm ID (Inside Diameter). The next smallest standard cro-moly steel bicycle tubing size available for the Sliding Tube 2 is 25.4 mm OD×24.2 mm ID. By installing the Bushing 101 with wall thickness of 0.8 mm into the Upper Top Tube 10 this creates a Bushing 101 ID of approximately 25.8 mm that provides an acceptable radial clearance gap of approximately 0.2 mm between Bushing 101 ID and the Sliding Tube 10 OD. It should be understood by a person skilled in the art, that clearance gaps either larger or smaller may be achieved by varying the Bushing 101 wall thickness, so as to be suitable for the available manufacturing tolerances.

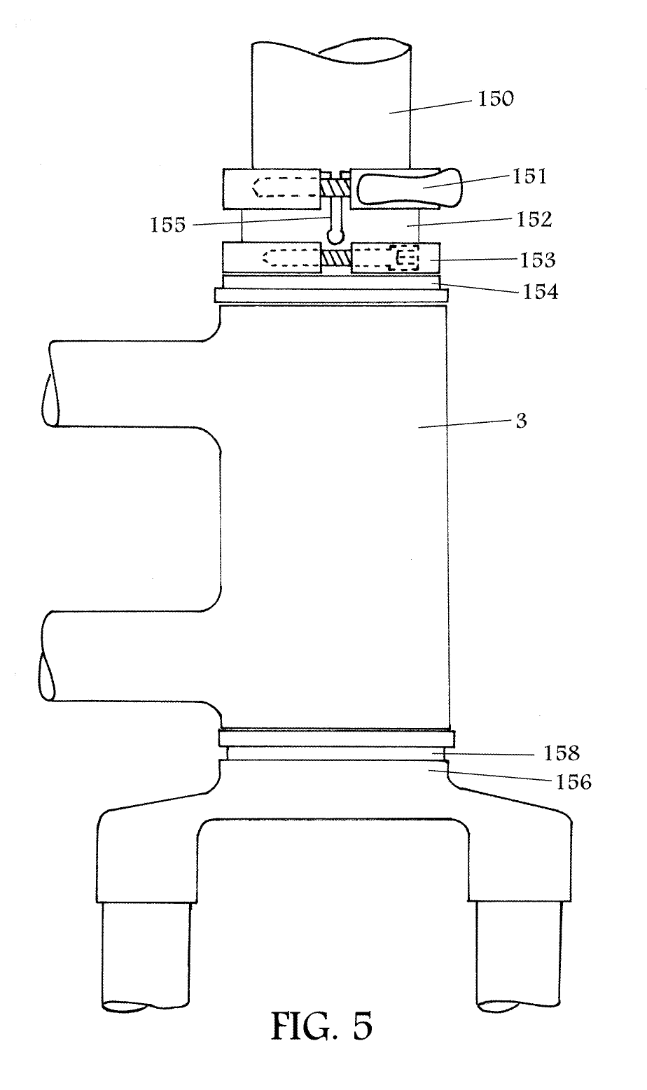

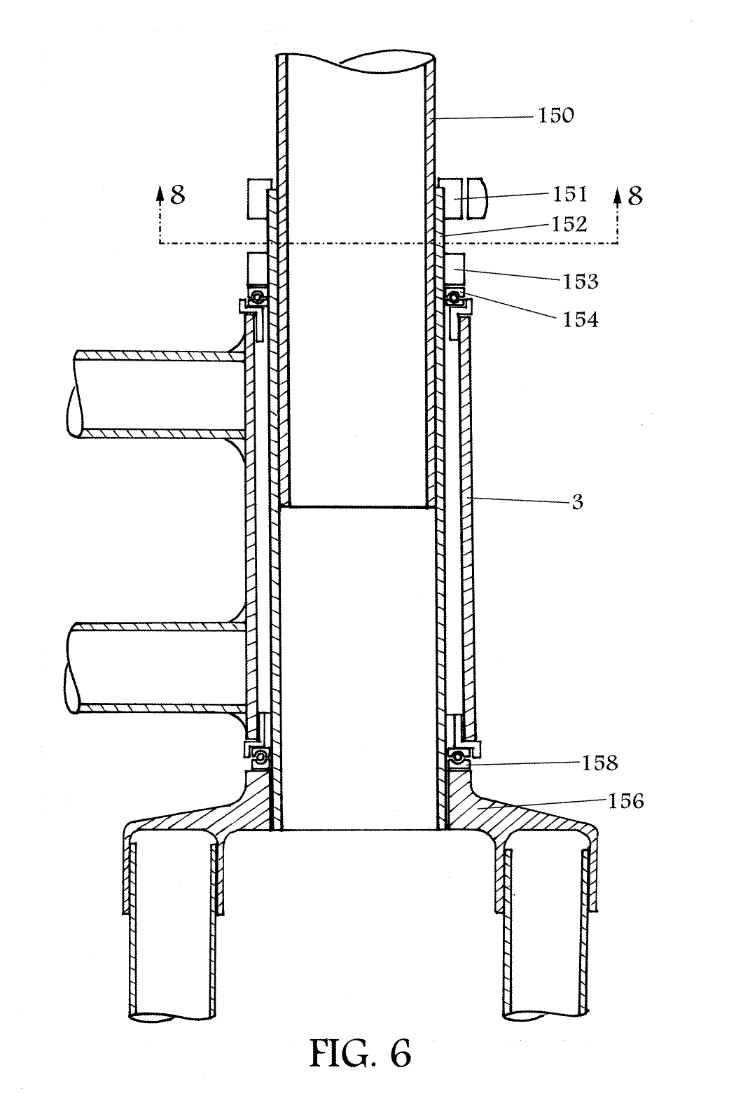

FIGS. 5 and 6 demonstrate an additional complementary design element of the preferred embodiment, an adjustable height steering column. It may be understood by one skilled in the art that certain items not directly related to the invention, such as seals, are not included in the figures for clarity. FIG. 5 is a partial view of the central portion of the Steering Assembly 7, and FIG. 6 is a sectional view of the same area.

In the case of most conventional steering columns found on bicycles currently, specialized hand tools and a more advanced knowledge of bicycle mechanics are required to be able to adjust the handlebar height, and it is therefore rarely undertaken on the road by typical cyclists.

As shown in FIGS. 5 and 6, a system to adjust handlebar height without tools is provided. Handlebar height adjustment is accomplished with the use of an internal telescoping column 150, which may be adjusted vertically from a first axial location to a second axial location. Telescopic movement is controlled with the use of a quick release clamp 151 (similar to those previously described above), which encircles the Slit Steerer Tube 152. When engaged, the quick release clamp 151 compresses Slit Steer Tube 152 so that it clamps onto the Telescopic Column 150, thereby locking them together.

In the preferred embodiment, the slit steerer tube 152 may be fixed axially within the head tube 3 with a shaft collar 153 fitted against the top bearing 154. The shaft collar 153 is a slotted cylindrical ring incorporating a socket head cap screw across the slot, which enables it to be tightened onto the slit steerer tube 152 below the slotted area 155. An upwards axial force may be applied to the fork crown 156, while simultaneously applying a downwards axial force on the shaft collar 153 to apply a compressive load to the top and bottom bearings, 154 and 158 respectively. With these forces maintained, the shaft collar 153 is tightened onto the slit steerer tube 152, so that both top bearings 154 and bottom bearings 158 operate under a light preload thereby preventing rattling or rocking. Once the shaft collar 153 is tightened during this initial assembly procedure, it remains fixed in place and does not need to be loosened to enable axial extension of the telescoping column 150. This is a significant benefit over the previous art, as it preserves the bearing preload and protects the bearings from exposure during the process of height adjustment.

A further refinement of the design is shown in FIG. 8, a cross section view of the telescoping column 150 and steerer tube 152 from FIG. 6. This view shows a key 180 located in a keyway 181 on the steerer tube 152 and mating with keyway 182 on the telescopic column 150, which constrains relative movement between steerer tube 152 and telescopic column 150 to a strictly axial direction, preventing angular rotation. The key and keyway system thereby serves to maintain the angular alignment of the handlebars to the front wheel during height adjustment, improving the ease with which handlebar height adjustments may be made. Similar mechanisms well known in the art, such as splines or pins, may instead be employed at the interface between steerer tube 152 and telescopic column 150 to constrain motion to purely axial movement. Alternatively, the steerer tube 152 and telescopic column 150 may be formed into non-circular cross sections, such as ovals or other convenient shapes, with the telescopic column nested inside the steerer tube, so that the non-circular cross sections prevent relative rotation.

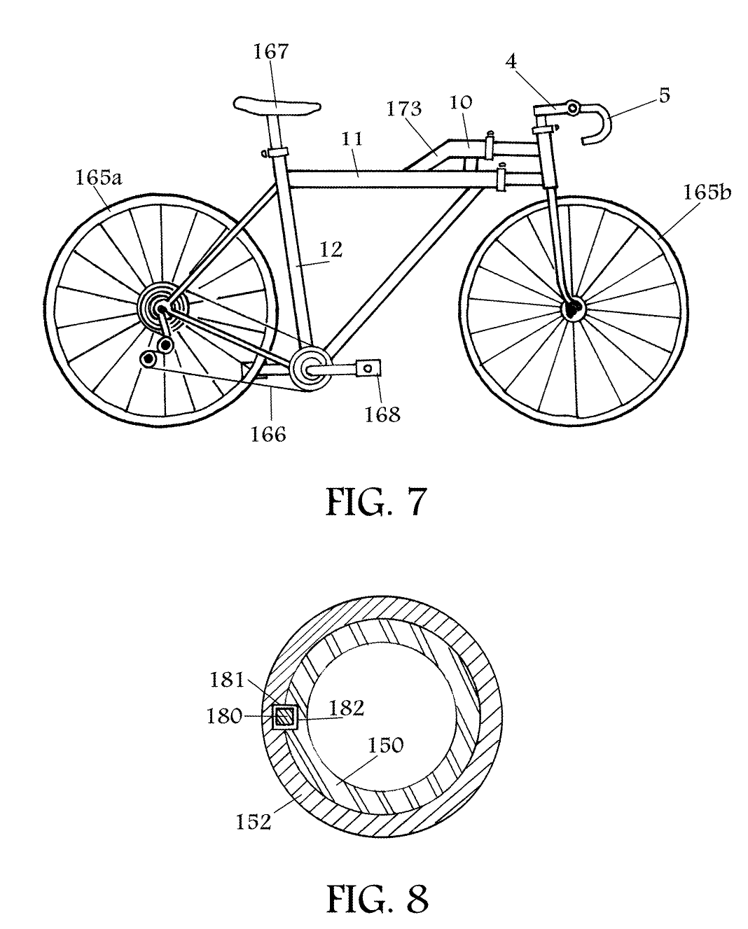

With reference to FIG. 7, a complete Extensible Bicycle is shown in context with conventional components such as wheels 165a and 165b, chain 166, saddle 167, pedals 168, stem 4, and handlebar 5 installed. Furthermore, a preferred embodiment is shown with the Upper Top Tube 10 truncated and attached to the Lower Top Tube 11. The reason for truncating the Upper Top Tube 10 is to provide the cyclist with additional stand-over clearance. With this feature, a cyclist with shorter legs is able to dismount and stand astride the bicycle with feet planted flat on the ground without coming into contact with the Upper Top Tube 10. The truncation may be accomplished by cutting the Upper Top Tube 10 and joining a short section of tube 173 at an angle to the horizontal Upper Top Tube 10. Alternatively, the rear portion 173 of the Upper Top Tube 10 may be bent to form a downward sloping angle so that it intersects with the Lower Top Tube 11. The reader will understand that while the Upper Top Tube 10 is truncated before reaching the seat tube 12, the functioning of the parallel portions of the Top Tubes 10 and 11 is identical to that previously described.

Although the present invention has been described and illustrated with respect to preferred embodiments and preferred uses thereof, it is not to be so limited since modifications and changes can be made therein which are within the full, intended scope of the invention as understood by those skilled in the art.

1. An extensible bicycle frame comprising:
a seat tube;
a head tube;
a top tube assembly connecting the seat tube to the head tube, the top tube assembly including:
a first female tube having a front end and a rear end, the rear end attached to the seat tube;
a first male tube having a front end and a rear end, the front end attached to the head tube and the rear end telescopically engaged with the front end of the first female tube;
wherein the length of the top tube assembly can be adjusted by telescopically sliding the first female tube within the first male tube; and
a locking mechanism for fixing the position of the first female tube relative to the first male tube.

2. The bicycle frame as in claim 1 further comprising a second top tube assembly located above and parallel with the top tube assembly, the second top tube assembly including:
a second female tube having a front end and a rear end, the rear end attached to the seat tube or first female tube; and
a second male tube having a front end and a rear end, the front attached to the head tube and the rear end telescopically engaged with the front end of the second female tube.

3. The bicycle frame as in claim 2 further comprising a second locking mechanism for fixing the position of the second female tube relative to the second male tube.

4. The bicycle frame as in claim 2 wherein the first and second top tube assemblies provide planar alignment between the head tube and the seat tube.

5. The bicycle frame as in claim 3 wherein the first locking mechanism and second locking mechanism are quick release clamps operatively engaged with the front end of the first and second female tubes respectively.

6. The bicycle frame as in claim 2 wherein the front end of each female tube has an axial slit with a relief hole at the proximal end of the slit to allow the tube to elastically and radially expand and contract.

7. The bicycle frame as in claim 2 wherein the front end of each female tube front end includes an internal bushing and the rear end of each male tube includes an external end stop to prevent inadvertent disassembly of each male tube from each female tube.

8. The bicycle frame as in claim 7 wherein each internal bushing has a bushing leading edge located adjacent the female tube front end, and each external end stop has an end stop leading edge located adjacent the male tube rear end and wherein each bushing and end stop leading edges are tapered to facilitate insertion of each male tube rear end into each female tube front end respectively.

9. The bicycle frame as in claim 3 wherein the first and second top tube assemblies provide planar alignment between the head tube and the seat tube.

10. The bicycle frame as in claim 9 wherein the first locking mechanism and second locking mechanism are quick release clamps operatively engaged with the front end of the first and second female tubes respectively; and wherein the front end of each female tube has an axial slit with a relief hole at the proximal end of the slit to allow the tube to elastically and radially expand and contract.

11. The bicycle frame as in claim 10 wherein the front end of each female tube front end includes an internal bushing having a bushing leading edge located adjacent the female tube front end, and the rear end of each male tube includes an external end stop having an end stop leading edge located adjacent the male tube rear end to prevent inadvertent disassembly of each male tube from each female tube, wherein each bushing and end stop leading edges are tapered to facilitate insertion of each male tube rear end into each female tube front end, respectively.

12. An adjustable steering column for a bicycle comprising:
a head tube;
a steerer tube having a top end and a bottom end, the bottom end operatively engaged within the head tube;
a telescopic tube having a bottom end telescopically engaged within the steerer tube; and
a steering column locking mechanism for fixing the position of the telescopic tube within the steerer tube;
wherein the height of the telescopic steering column can be adjusted without tools.

13. The adjustable steering column as in claim 12 wherein the steering column locking mechanism is a quick release clamp operatively engaged with the top end of the steerer tube.

14. The adjustable steering column as in claim 13 wherein the top end of the steerer tube has an axial slit with a relief hole to allow the steerer tube to elastically and radially expand and contract.

15. The adjustable steering column as in claim 12 wherein the steerer tube and telescopic tube further include an anti-rotation mechanism to prevent relative angular displacement during height adjustment.

16. The adjustable steering column as in claim 15 wherein the anti-rotation mechanism includes a key on the steerer tube and a keyway on the telescopic tube.

17. The adjustable steering column as in claim 12 wherein the cross-section of the telescopic tube and the steerer tube are non-circular to prevent relative angular displacement during height adjustment.

18. An adjustable bicycle comprising:
an adjustable frame assembly, the adjustable frame assembly including:
a seat tube;
a head tube;
a top tube assembly connecting the seat tube to the head tube, the top tube assembly including:
a first female tube having a front end and a rear end, the rear end attached to the seat tube;
a first male tube having a front end and a rear end, the front end attached to the head tube and the rear end telescopically engaged with the front end of the first female tube;
wherein the length of the top tube assembly can be adjusted by telescopically sliding the first female tube within the first male tube; and
a locking mechanism for fixing the position of the first female tube relative to the first male tube;
and
an adjustable steering column assembly, the adjustable steering column assembly including:
a steerer tube having a top end and a bottom end, the bottom end operatively engaged within the head tube;
a telescopic tube having a bottom end telescopically engaged within the steerer tube; and
a steering column locking mechanism for fixing the position of the telescopic tube within the steerer tube;
wherein the height of the telescopic steering column can be adjusted without tools.
